(19) United States
(12) Patent Application Publication
(10) Pub. No.: US 2026/0269154 A1
(43) Pub. Date: Sep. 10, 2026

(54) VISUALLY INDICATIVE KEYBOARD

(71) Applicant: NIANBIN PANG, SHENZHEN CITY (CN)

(72) Inventor: NIANBIN PANG, SHENZHEN CITY (CN)

(21) Appl. No.: 19/537,426

(22) Filed: Feb. 11, 2026

(30) Foreign Application Priority Data
Mar. 7, 2025 (CN) 202520414966.3

(51) Int. Cl. H01H 13/83; H01H 3/12

(52) U.S. Cl. CPC H01H 13/83; H01H 3/125

(57) ABSTRACT

A visually indicative keyboard is provided, including a front case, where at least one accommodation hole is provided on the front case; at least one key made of light-transmitting materials, disposed in the accommodation hole and capable of performing reciprocating movement relative to the accommodation hole; a display module, disposed below the front case for providing a visually indicative image to a user via the key; and a reset module, including a first magnet and a second magnet. At least one side adjacent to the accommodation hole is provided with a first groove, and the first magnet is disposed in the first groove. The key includes a plurality of side surfaces, at least one side surface of the key is provided with a second groove, and the second magnet is disposed in the second groove.

### CROSS-REFERENCE TO RELATED PATENT APPLICATION

The present invention claims priority to Chinese Patent Application No. 2025204149663, entitled “VISUALLY INDICATIVE KEYBOARD”, filed with the China National Intellectual Property Administration on Mar. 7, 2025, the entire contents of which are incorporated herein by reference.

### FIELD OF THE DISCLOSURE

The present invention relates to the technical field of keyboards, and specifically, to a visually indicative keyboard.

### BACKGROUND OF THE DISCLOSURE

With the continuous advancement of technology, visually indicative keyboards have attracted widespread attention due to their intuitive and vivid key designs, powerful customization features, and high user engagement. The customizable features of backlit keys allow users to adjust function settings in real time according to their actual needs, providing a more intuitive and convenient control interface.

Existing visually indicative keyboards typically utilize elastic materials and thin-film circuits to enable key feedback and reset. However, the elastic materials are prone to aging, wear, or failure over extended use, leading to unresponsive key feedback or failure to reset properly. In addition, the thin-film circuits suffer from issues such as poor triggering accuracy and short key lifespan. Therefore, there is an urgent need for a reset mechanism with long-term stability to overcome the limitations of existing elastic materials and thin-film circuits in terms of durability and precision.

### SUMMARY OF THE DISCLOSURE

The technical problem to be resolved by the present invention is to provide a visually indicative keyboard aiming at overcoming the limitations in durability and precision of existing elastic materials and thin-film circuits in conventional visually indicative keyboards, thereby addressing the shortcomings in the prior art.

In view of the defects and shortcomings in the prior art, an objective of the present invention is to provide a visually indicative keyboard, including:
a front case, where at least one accommodation hole is provided on the front case; at least one key made of light-transmitting materials, disposed in the accommodation hole and capable of performing reciprocating movement relative to the accommodation hole;
a display module, disposed below the front case for providing a visually indicative image to a user via the key; and
a reset module, where the reset module includes a first magnet and a second magnet.

At least one side adjacent to the accommodation hole is provided with a first groove, and the first magnet is disposed in the first groove; and the key includes a plurality of side surfaces, at least one side surface of the key is provided with a second groove, and the second magnet is disposed in the second groove.

When the key is not pressed, a top surface of the key is higher than a top surface of the front case, and an initial state is maintained by the magnetic force between the first magnet and the second magnet; or when the user presses the key, the magnetic force provides a restoring force for resetting the key.

Further, at least one side surface of the key is provided with a guide strip, an inner wall of the accommodation hole is provided with a guide groove that is engaged with the guide strip, and when the user presses the key, the guide strip slides along the guide groove.

Further, at least one inner wall of the accommodation hole is further provided with a first limiting portion, at least one side surface of the key is further provided with a second limiting portion, and when the key is not pressed, the second limiting portion abuts against the first limiting portion.

Further, the first limiting portion includes a first sliding surface, a first cross-sectional surface, and a second sliding surface, with the first cross-sectional surface connected between the first sliding surface and the second sliding surface; the second limiting portion includes a third sliding surface, a second cross-sectional surface, and a fourth sliding surface, with the second cross-sectional surface connected between the third sliding surface and the fourth sliding surface; and when the key is not pressed, the second cross-sectional surface abuts against the first cross-sectional surface.

Further, the visually indicative keyboard further includes a supporting member and a bottom case, where the bottom case is detachably connected to the front case, the supporting member is provided with a limiting member, and the limiting member is configured to secure a circuit board.

Further, the visually indicative keyboard further includes a detection module, where the detection module is configured to sense an action of the key.

Further, the detection module includes a touch panel disposed between the display module and the key, and when the key is pressed, the touch panel is capable of detecting an input signal of the key through contact with the key.

Further, the detection module includes a light-sensitive lamp panel and an optical sensor disposed on the light-sensitive lamp panel, and when the key is pressed, the optical sensor can detect the input signal of the key through light intensity, reflection, refraction, or obstruction.

Further, the detection module includes a magnetic field intensity sensing device, and when the key is pressed, the magnetic field intensity sensing device is capable of detecting the input signal of the key through changes in the magnetic field.

Further, the visually indicative keyboard further includes a PVC top cover, where the PVC top cover is disposed between the display module and the front case.

According to the embodiments of the present invention, the interaction between the second magnet on the side surface of the key and the first magnet in the groove of the front case keeps the key in an initial position when the key is not pressed and enables automatic reset after the user presses and releases the key. An additional mechanical elastic component of the reset module is not required, and a conventional elastic thin-film structure is replaced, to enable stable reset of the key, avoid issues such as aging and wear of an elastic material, and low triggering accuracy and short lifespan of a thin-film circuit, and enhance the durability and reliability of the key.

In addition, the feedback force of the key can be optimized to improve the operation feel by adjusting the magnetic force.

### BRIEF DESCRIPTION OF THE DRAWINGS

To more clearly illustrate the technical solution in the embodiments of the present invention or in the prior art, the accompanying drawings required to be used in the description of the embodiments or the prior art are briefly introduced below. It is obvious that the accompanying drawings in the description below are only some embodiments of the present invention, and those of ordinary skill in the art can obtain other accompanying drawings according to these accompanying drawings without creative efforts.

FIG. 1 is a schematic diagram of a structure of a first embodiment according to the present invention;

FIG. 2 is a schematic diagram of a structure of a first embodiment from another perspective according to the present invention;

FIG. 3 is a top view of a first embodiment according to the present invention;

FIG. 4 is a sectional view of FIG. 3 along A-A;

FIG. 5 is an enlarged schematic diagram of A in FIG. 4;

FIG. 6 is a sectional view of FIG. 3 along B-B in an initial state;

FIG. 7 is a sectional view of FIG. 3 along B-B in a pressed state;

FIG. 8 is a schematic diagram of a structure of a second embodiment according to the present invention; and

FIG. 9 is a schematic diagram of a structure of a third embodiment according to the present invention.

### REFERENCE NUMERALS

1. Front case; 11. Top surface; 2. Accommodation hole; 21. First groove; 22. First limiting portion; 221. First sliding surface; 222. First cross-sectional surface; 223. Second sliding surface; 23. Guide groove; 3. Key; 31. Second groove; 32. Second limiting portion; 321. Third sliding surface; 322. Second cross-sectional surface; 323. Fourth sliding surface; 33. Guide strip; 4. Reset module; 41. First magnet; 42. Second magnet; 5. Display module; 6. Support member; 61. Mounting post; 62. Accommodation groove; 63. Limiting member; 64. Limiting post; 65. Cable channel; 7. Bottom case; 71. Through hole; 8. Circuit board; 9. Detection module; 91. Touch panel; 92. Light-sensitive lamp panel; 93. Optical sensor; 94. Magnetic field strength sensing device; and 10. PVC top cover.

### DETAILED DESCRIPTION OF THE EXEMPLARY EMBODIMENTS

The present invention is further described in detail below with reference to the accompanying drawings.

This specific embodiment is merely an explanation of the present invention, but not a limitation of the present invention. After reading this specification, those skilled in the art can make non-creative modifications to this embodiment based on a requirement, and these modifications are all protected by the Patent Law as long as they are within the scope of the claims of the present invention.

To make the purpose, technical solutions, and advantages of the embodiments of the present invention clearer, the technical solutions in the embodiments of the present invention will be clearly and completely described below with reference to the accompanying drawings in the embodiments of the present invention. It is apparent that the described embodiments are merely a part rather than all of the embodiments of the present invention. The assemblies of embodiments of the present invention, as generally described and illustrated in the figures herein, can be arranged and designed in a wide variety of different configurations.

Therefore, the following detailed descriptions of embodiments of the present invention provided in the accompanying drawings are not intended to limit the scope of the present invention that claims protection, but merely to represent selected embodiments of the present invention. Based on the embodiments of the present invention, all other embodiments obtained by those of ordinary skill in the art without creative efforts fall within the protection scope of the present invention.

### First Embodiment

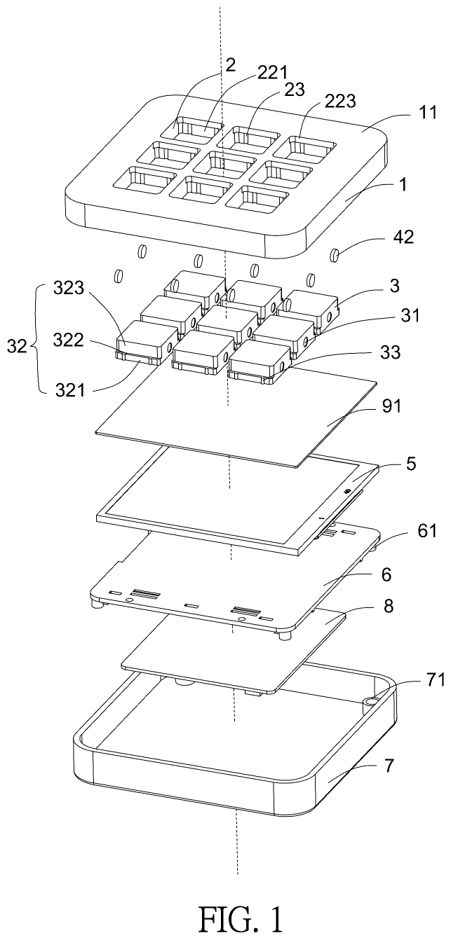

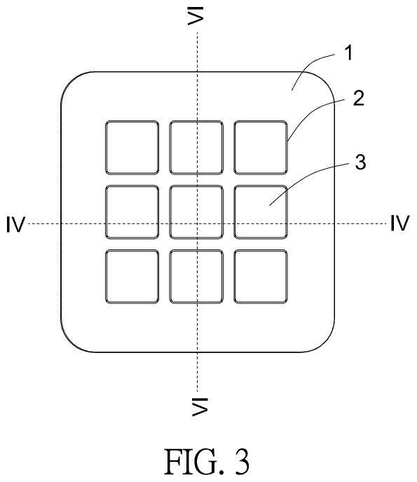

Refer to FIG. 1 to FIG. 7. An embodiment of the present invention provides a visually indicative keyboard, including a front case 1, a reset module 4, and a display module 5.

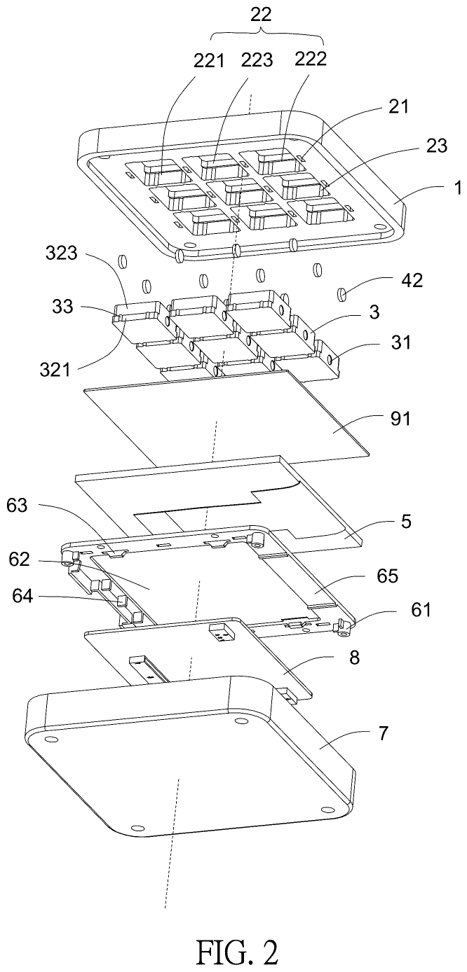

Refer to FIG. 1 and FIG. 2. This embodiment includes a front case 1, where at least one accommodation hole 2 is provided on the front case 1, and at least one side adjacent to the accommodation hole 2 is provided with a first groove 21; and at least one key 3 made of light-transmitting materials disposed in the accommodation hole 2, where the key 3 is capable of performing reciprocating movement relative to the accommodation hole 2, the key 3 includes a plurality of side surfaces, and at least one side surface of the key 3 is provided with a second groove 31.

In this embodiment, an example in which at least one accommodation hole 2 is provided on the front case 1 is used for description. However, this embodiment is not limited thereto. A plurality of accommodation holes 2 may be provided on the front case 1, and a part of the accommodation holes 2 may be left vacant without installing the key 3. The shape of the accommodation hole 2 is not limited to a square, and may be in another shape suitable for a specific application scenario, for example, a polygon, a circle, an oblong, or the like.

In addition, the vacant accommodation hole 2 can be directly used for displaying the content of the display module 5, and internal elements can be capped and protected by transparent materials. The vacant accommodation hole 2 may also serve as an indicator light window, a heat dissipation hole, or a window of an optical sensor 93, or be used for embedding another functional component to extend device functions, where the functional component may be a QR code or an NFC tag.

In this embodiment, an example in which at least one side surface of the key 3 is provided with the second groove 31 is used for description. However, this embodiment is not limited thereto. When a quantity of side surfaces of the key 3 is even, the second grooves 31 may be disposed, but not limited to, on only one side surface, on two adjacent side surfaces, on opposite side surfaces, on every other side surface, on all side surfaces, or on any quantity of side surfaces. When a quantity of side surfaces of the key 3 is odd, the second grooves 31 may be disposed, but not limited to, on only one side surface, on every other side surface, on all side surfaces, or on any quantity of side surfaces. In this embodiment, the quantity and the position of the second grooves 31 can be flexibly adjusted according to a specific application requirement, to optimize the structural performance and the use effect.

It should be noted that, the shape of the key 3 is not limited to a polygon, but may also be circular, elliptical, or the like. In this case, the magnets are not restricted to being installed on the side of the key 3, but are defined relative to the key 3. For example, the magnets may be installed on opposite sides of the key 3, or the magnets may be arranged in a polygonal configuration relative to the key 3.

In this embodiment, the second groove 31 may be formed by recessing inward from the inner wall of the side surface of the key 3, recessing outward from the outer wall of the side surface of the key 3, recessing upward from the bottom of the side surface of the key 3, or recessing downward from the top of the side surface of the key 3. The shape of the second groove 31 may be optimized as needed. In addition to a rectangular groove, an arc-shaped groove, a wedge-shaped groove, a stepped groove, or another profile configuration may be used to enhance the fixation of the second magnet 42.

In this embodiment, the key 3 made of light-transmitting materials is used to enable light transmission, allowing the key 3 to display internal indication information or backlight effects when illuminated by a light source. This enhances visualization and user experience. The light-transmitting materials of the key 3 may be transparent or translucent, for example, acrylic, polycarbonate, glass, or another high-transmittance material suitable for a keyboard structure. In addition, the key 3 made of light-transmitting materials may undergo processes such as frosting, coating, etching, or laser engraving to optimize light distribution, reduce glare, or improve visually indicative effects.

In this embodiment, an example of the key 3 made of light-transmitting materials is used for description. However, this embodiment is not limited thereto. The front case 1 and the key 3 can be made of transparent materials, and the shape of the key 3 is not limited to a square, and may be in another shape suitable for a specific application scenario, for example, a polygon, a circle, an oblong, or the like.

In this embodiment, the first groove 21 is located on the top surface 11 of the front case 1 and is formed by recessing upward from the lower surface of the top surface 11. However, this embodiment is not limited thereto. The first groove 21 may also be formed by recessing downward from the upper surface of the top surface 11, or by recessing inward from the inner wall of the accommodation hole 2. The shape of the first groove 21 may also be optimized as needed. In addition to a rectangular groove, an arc-shaped groove, a wedge-shaped groove, a stepped groove, or another profile configuration may be used to enhance the fixation of the first magnet 41.

In this embodiment, an example in which at least one side adjacent to the accommodation hole 2 is provided with the first groove 21 is used for description. However, this embodiment is not limited thereto. The first groove 21 may be located on any side of the accommodation hole 2, on opposite sides, on adjacent sides, or even on a plurality of sides surrounding the accommodation hole 2. The quantity and position of the first grooves 21 may correspond to those of the second grooves 31.

In this embodiment, the visually indicative keyboard further includes a reset module 4, where the reset module 4 includes a first magnet 41 and a second magnet 42. The first magnet 41 is disposed in the first groove 21, and the second magnet 42 is disposed in the second groove 31. The first magnet 41 and the second magnet 42 may be strong magnets, the shape of the first magnet 41 may correspond to that of the first groove 21, and the shape of the second magnet 42 may correspond to that of the second groove 31.

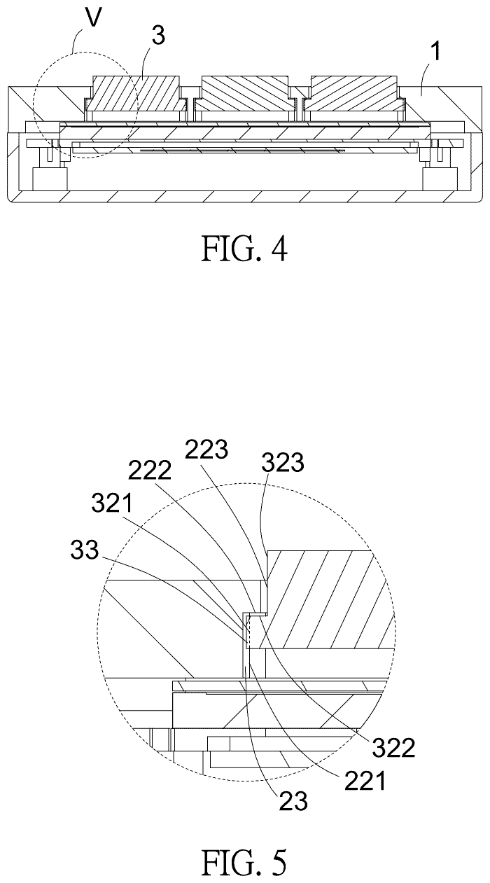

Refer to FIG. 4 to FIG. 7. In the embodiment, the first magnet 41 is disposed in the first groove 21, and the second magnet 42 is disposed in the second groove 31. The magnetic force between the magnets provides an upward attractive or repulsive force, causing the key 3 to remain suspended or in a standby state without any external force applied, thereby preventing the key from sinking due to its own weight. When the user applies an external force to press the key 3, the key 3 moves downward against the magnetic force between the first magnet 41 and the second magnet 42, gradually bringing the top surface of the key 3 closer to or below the top surface 11 of the front case 1. Upon removal of the external force, the magnetic force between the first magnet 41 and the second magnet 42 provides a restoring force for resetting the key 3 to its initial height without additional external intervention, thereby enabling the reset function of the key 3.

Further, the magnetic force between the first magnet 41 and the second magnet 42 can be optimized by adjusting the magnet material, size, shape, and magnetic pole arrangement. Specifically, the first magnet 41 and the second magnet 42 may be arranged with the same poles facing each other or opposite poles facing each other to control the rebound features of the key 3, thereby simulating or exceeding the tactile feel of a mechanical switch.

It should be noted that, in this embodiment, different requirements are imposed on the structural layout when the first magnet 41 and the second magnet 42 are reset through an attractive force or a repulsive force. Specifically, when the attractive force is applied, to achieve optimal reset performance, the first magnet 41 should be disposed at a relatively high location, that is, close to the top surface of the accommodation hole 2, so that in the initial state, the first magnet 41 and the second magnet 42 may be on the same horizontal plane, or the first magnet 41 is slightly lower than the second magnet 42. This ensures the key 3 remains stably suspended when no external force is applied. Conversely, when the repulsive force is applied for reset, the first magnet 41 is disposed in the lower area of the accommodation hole 2, and the second magnet 42 is disposed at a relatively high location. This configuration significantly reduces the effective interaction distance between the first magnet 41 and the second magnet 42. Since the magnetic field strength between the magnets increases exponentially as the distance between the magnets decreases, when the distance between the first magnet 41 and the second magnet 42 is shortened, the magnetic field strength increases dramatically, thereby generating sufficient reset force within a limited space. In other words, the compact magnet arrangement reduces the minimum required magnetic field interaction distance for reset. This not only improves the efficiency of the magnetic interaction but also allows for a significant reduction in the thickness of both the front case 1 and the key 3. In addition, the key 3 as a whole can get closer to the display module 5, optimizing the device's appearance and display effect.

Preferably, the repulsive force is applied between the first magnet 41 and the second magnet 42 in this embodiment.

Refer to FIG. 1 and FIG. 2, in the embodiment, the visually indicative keyboard further includes a display module 5, disposed below the front case 1 for providing a visually indicative image to a user via the key 3. The display module 5 may be one of a TFT display screen, an LCD display screen, an OLED display screen, or an LED dot matrix module.

According to the embodiments of the present invention, the interaction between the second magnet 42 on the side surface of the key 3 and the first magnet 41 in the groove of the front case 1 keeps the key 3 in an initial position when the key is not pressed and enables automatic reset after the user presses and releases the key. An additional mechanical elastic component of the reset module 4 is not required, and a conventional elastic thin-film structure is replaced, to enable the stable reset of the key 3, avoid issues such as aging and wear of an elastic material, and low triggering accuracy and short lifespan of a thin-film circuit, and enhance the durability and reliability of the key 3.

In this embodiment, an initial state of the key 3 under normal conditions is maintained by the magnetic force between the first magnet 41 and the second magnet 42. When the user presses the key 3, the magnetic force provides a restoring force for resetting the key 3. However, the present invention is not limited thereto.

Refer to FIG. 4 and FIG. 5. Further, at least one inner wall of the accommodation hole 2 is provided with a first limiting portion 22, and at least one side surface of the key 3 is provided with a second limiting portion 32. The first limiting portion 22 includes a first sliding surface 221, a first cross-sectional surface 222, and a second sliding surface 223, with the first cross-sectional surface 222 connected between the first sliding surface 221 and the second sliding surface 223. The second limiting portion 32 includes a third sliding surface 321, a second cross-sectional surface 322, and a fourth sliding surface 323, with the second cross-sectional surface 322 connected between the third sliding surface 321 and the fourth sliding surface 323. The first sliding surface 221 and the second sliding surface 223 may be inclined to facilitate the sliding of the key 3 along the surfaces, thereby enabling a smooth reset. Alternatively, the first sliding surface 221 and the second sliding surface 223 may be arranged vertically. When the key 3 is not pressed, the second cross-sectional surface 322 abuts against the first cross-sectional surface 222, to restrict further upward movement of the key 3 and ensure that the key 3 remains in the initial state. When the key 3 is pressed, the third sliding surface 321 slides along the first sliding surface 221. During the rebound and reset process of the key 3, the fourth sliding surface 323 slides along the second sliding surface 223, enabling the key 3 to restore to the initial state.

Preferably, a limiting structure may be formed on each of the two opposite inner wall surfaces of the accommodation hole 2, on two side surfaces of the key 3, or on all inner wall surfaces. This embodiment is not limited to a specific limiting structure, and a specific form and arrangement can be adjusted according to an actual application requirement, to optimize the rebound performance and durability of the key 3.

In this embodiment, the third sliding surface 321 slides along the first sliding surface 221, so that the key 3 is capable of performing reciprocating movement in the accommodation hole 2. However, the present invention is not limited thereto.

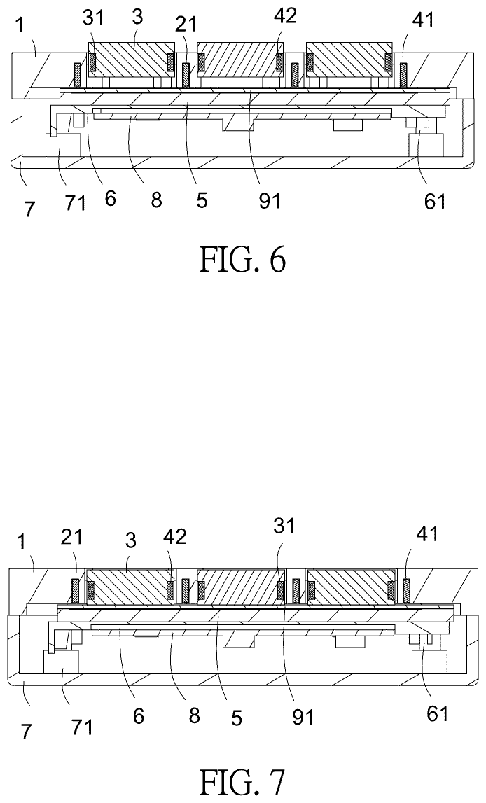

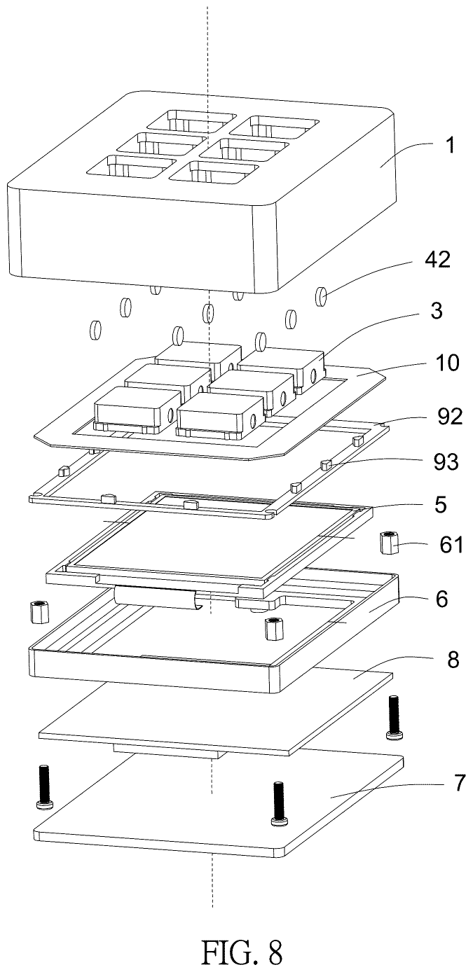

Refer to FIG. 6 and FIG. 7. Further, at least one side surface of the key 3 is provided with a guide strip 33, an inner wall of the accommodation hole 2 is provided with a guide groove 23 that is engaged with the guide strip 33, and when the user presses the key 3, the guide strip 33 slides along the guide groove 23.

In this embodiment, an example in which at least one side surface of the key 3 is provided with the guide strip 33 is used for description. However, this embodiment is not limited thereto. The shape of the guide strip 33 includes, but is not limited to, semicircular, sharply triangular, rectangular, trapezoidal, or wedge-shaped. The appropriate shape of the guide strip 33 can be selected based on actual usage scenarios to optimize the sliding performance and durability. In addition, the shape of the guide groove 23 corresponds to that of the guide strip 33.

Further, the guide strip 33 may be disposed on the third sliding surface 321 or the fourth sliding surface 323 of the key 3, or on both the third sliding surface 321 and the fourth sliding surface 323, to ensure smooth movement of the key 3 along the guide groove 23 during pressing and reset operations. The specific location of the guide strip 33 on the sliding surface may be at the center of the third sliding surface 321 or the fourth sliding surface 323, to enhance sliding stability, or may be on both sides of the third sliding surface 321 or the fourth sliding surface 323, to provide additional lateral constraint and prevent the horizontal wobbling of the key 3. In addition, the position of the guide groove 23 corresponds to that of the guide strip 33.

Further, the guide strip 33 may be disposed on only one side surface of the key 3, on two opposite side surfaces of the key 3, or on a plurality of side surfaces of the key 3, to further prevent the offset or wobbling of the key 3 during movement. The structure of the guide strip 33 in this embodiment can be flexibly adjusted according to an actual application requirement, to optimize the sliding precision, stability, and service life of the key 3. In this embodiment, the guide strips 33 are disposed on the plurality of side surfaces of the key 3. If one or more guide strips 33 are damaged or fail, the remaining guide strips 33 can continue to function, thereby prolonging the service life of the key 3. In addition, the quantity of guide grooves 23 corresponds to that of guide strips 33.

It should be noted that, in this embodiment, for example, the guide strips 33 are disposed on both opposite sides of the key 3, the second magnets 42 are disposed on both opposite sides of the key 3, and the first magnets 41 are disposed on both opposite sides of the accommodation hole 2. Since the reset function of the key 3 relies on the magnetic force between the first magnet 41 and the second magnet 42, if the key 3 is installed in a wrong direction, the magnetic force may not be properly generated or the effect of the magnetic force may be significantly weakened, thereby affecting the reset performance of the key 3. In view of this, in this embodiment, two guide strips 33 are respectively disposed on two opposite sides of the key 3, and the two guide strips 33 on the opposite sides of the key 3 have different spacings, thereby forming a fool-proof structure. Through this design, it ensures that the key 3 can only be correctly installed in a predetermined direction during production, assembly, use, and maintenance. This prevents functional failure caused by reverse installation of the key 3, improves assembly accuracy, and reduces additional production and maintenance costs.

In this embodiment, an example in which the guide strips 33 with different spacings are disposed on two opposite sides of the key 3 is used for description. However, this embodiment is not limited thereto. The quantity and arrangement of the guide strips 33 can be adjusted according to a specific requirement, to further enhance the installation accuracy and fool-proof effect of the key 3.

Refer to FIG. 1 to FIG. 7. Further, the visually indicative keyboard further includes a supporting member 6 and a bottom case 7, where the bottom case 7 is detachably connected to the front case 1, the supporting member 6 is provided with a limiting member 63, and the limiting member 63 is configured to secure a circuit board 8.

Specifically, the bottom case 7 includes four through holes 71, the supporting member 6 includes four mounting posts 61 corresponding to the through holes 71, and the through holes 71 and the mounting posts 61 are connected by screwing, riveting or buckling. The bottom case 7 and the support member 6 directly form an accommodation space for the circuit board 8.

Further, the support member 6 is also provided with an accommodation groove 62 and a plurality of limiting members 63. The accommodation groove 62 is configured to accommodate part or all of the circuit board 8, and the limiting members 63 are configured to further secure the circuit board 8, ensuring stable installation between the bottom case 7 and the support member 6, to prevent displacement or loosening during use. In this embodiment, the limiting member 63 adopts a snap-fit structure and may include a plurality of elastic clips or rigid limiting blocks. During installation, the circuit board 8 can be pressed or slid into the clips and secured at its edges by the limiting blocks, enabling stable installation and convenient disassembly.

Further, the support member 6 is also provided with a plurality of limiting posts 64, where the limiting posts 64 are disposed at the edges of the accommodation groove 62, to further limit and secure the circuit board 8. The height of the limiting posts 64 can correspond to the thickness of the circuit board 8, allowing the circuit board 8 to fit snugly between the limiting posts 64 and the support member 6 during installation, forming a stable positioning support.

Further, a cable channel 65 is provided on one side of the support member 6. The display module 5 is located on the side of the support member 6 close to the front case 1, and the ribbon cable of the display module 5 can be electrically connected to the circuit board 8 through the cable channel 65. The cable channel 65 is arranged along the lower surface or the upper surface of the support member 6, allowing the ribbon cable to pass through smoothly.

Further, the visually indicative keyboard further includes a detection module 9, where the detection module 9 is configured to sense an action of the key 3. The detection module 9 includes a touch panel 91 disposed between the display module 5 and the key 3, and when the key is pressed, the touch panel 91 is capable of detecting an input signal of the key 3 through contact with the key 3.

In this embodiment, the touch panel 91 may be a resistive TP or a capacitive TP. When the user presses the key 3, the bottom surface of the key 3 comes into contact with or approaches the surface of the touch panel 91, thereby triggering signal detection. For the resistance TP, when the key 3 is pressed, the upper and lower conductive films come into contact, allowing the touch panel 91 to detect a change in resistance at a specific location, thereby generating an input signal of the key 3. For the capacitance TP, the proximity or pressing of the key 3 alters the electric field distribution on the surface of the touch panel 91, enabling the panel to detect a change in capacitance, and determine the input state of the key 3 accordingly.

It should be noted that, the resistive TP and the capacitive TP use two touch-sensing technologies for detecting the input signal of the key 3. The resistive TP primarily relies on changes in contact between two conductive films for signal detection, and the capacitive TP senses touch operations by detecting changes in the electric field.

Further, the touch panel 91 is made of a transparent material, allowing the touch panel to be installed above the display module 5 without blocking or affecting the display effect. In addition, the touch panel 91 is designed to be thin, enabling the touch panel to fit snugly between the display module 5 and the key 3. This allows for input detection of the key 3 without increasing the overall size of the device.

### Second Embodiment

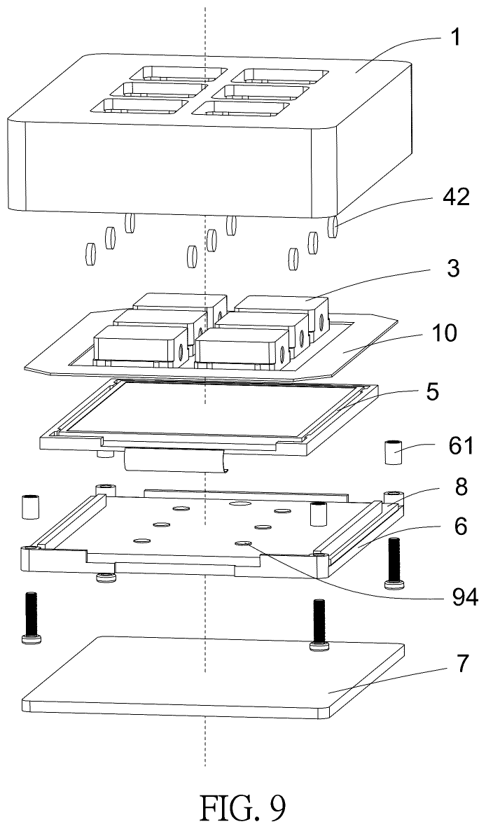

Refer to FIG. 8. The difference between this embodiment and the foregoing embodiment is that the detection module 9 includes a light-sensitive lamp panel 92 and an optical sensor 93. The light-sensitive lamp panel 92 is located above the display module 5 and is enclosed in the display module 5, or is only enclosed in the display area of the display module 5. The optical sensor 93 is disposed on the light-sensitive lamp panel 92 and corresponds to the position of the key 3. When the key is pressed, the optical sensor 93 can detect the input signal of the key 3 through light intensity, reflection, refraction, or obstruction.

Specifically, the light-sensitive lamp panel 92 is disposed around a single row or column of the keys 3, with at least one optical sensor 93 disposed at a side of each key 3. This allows a light source and a receiver to cover the entire single row or column of the keys 3. One side of each key 3 corresponds to a light transmitter, and the opposite side corresponds to a light receiver. When the key 3 is not pressed, the optical signal can propagate or reflect normally. When the user presses the key 3, the optical path on the side of the key 3 changes, and the optical sensor 93 detects changes in the optical signal, thereby determining the input state of the key 3.

Preferably, when there are six or fewer keys 3, the transmitter and the receiver of the optical sensor 93 can be integrated and installed along the horizontal and vertical sides of the matrix of the keys 3. When the optical sensor 93 emits light, unpressed keys 3 reflect less light, forming a baseline for signal reflection. When the key 3 is pressed, the surface of the key 3 moves closer to the optical sensor 93, increasing the intensity of reflected light. The optical sensor 93 can accurately determine the position of the pressed key 3 by detecting changes in reflected light intensity in both horizontal and vertical directions with reference to optical signal data from different sensors, and support recognition of simultaneous pressing of a plurality of keys 3. The input detection of the key 3 is achieved through changes in the reflection intensity in this method. Compared to conventional optical obstruction detection methods, the quantity of optical sensors 93 is reduced while detection accuracy and anti-interference capability are improved.

Further, in this embodiment, the visually indicative keyboard further includes a PVC top cover 10, where the PVC top cover 10 is disposed between the display module 5 and the front case 1. The PVC top cover at least covers the non-display area of the display module 5 and is attached or secured to the lower surface of the top surface 11, to provide structural support and protection. The PVC top cover 10 helps prevent external impacts, dust, and moisture from damaging the display module 5, thereby enhancing the device's durability. In addition, the PVC top cover helps optimize optical properties, reduce ambient light interference, and improve the clarity of the screen display. In addition, the PVC top cover 10 may enhance the overall structural stability of the device, preventing the display module 5 from loosening or deforming due to long-term use or external forces, thereby ensuring the device's reliability and service life.

### Third Embodiment

Refer to FIG. 9. The difference between this embodiment and the foregoing embodiment lies in that the detection module 9 includes a magnetic field intensity sensing device 94, and when the key is pressed, the magnetic field intensity sensing device 94 is capable of detecting an input signal of the key 3 through changes in the magnetic field.

In this embodiment, the magnetic field intensity sensing device 94 may employ magnetic field detection elements such as a Hall sensor, a magnetoresistive sensor (MR sensor), a magnetic induction coil, or the like. Based on the Hall effect, the Hall sensor achieves input detection of the key 3 by measuring changes in the magnetic field in a vertical direction. The magnetoresistive sensor determines the state of the key 3 by detecting changes in the direction or intensity of the magnetic field. The magnetic induction coil can sense changes in magnetic flux that is then converted into an electrical signal for detection.

The Hall sensor is preferably employed in this embodiment. The Hall sensor offers advantages such as high sensitivity, non-contact detection, a long service life, and strong anti-interference capability.

Further, the magnetic field intensity sensing device 94 may be disposed below or beside the key 3, or directly installed on the circuit board 8 and electrically connected to the circuit board 8, to get closer to the second magnet 42 inside the key 3 for precise detection of changes in the magnetic field during the pressing of the key 3. In addition, the quantity and layout of the magnetic field sensing devices may be optimized based on the structure of the matrix of the keys 3, for example, assigning a single sensing device to each key 3 or using row-and-column scanning to detect the status of the plurality of keys 3, thereby improving detection efficiency.

In this embodiment, each key 3 is internally provided with a second magnet 42, disposed opposite the magnetic field intensity sensing device 94. When the key 3 is not pressed, the distance between the second magnet 42 and the magnetic field sensing device is relatively large, and the magnetic field strength detected by the magnetic field sensing device remains at a baseline level. When the user presses the key 3, the second magnet 42 moves downward or laterally, causing a change in the magnetic field strength received by the magnetic field sensing device. When the key is vertically pressed, the second magnet 42 approaches the magnetic field sensing device, resulting in an increase in the magnetic field strength; and when the key horizontally slides, a direction of the second magnet 42 changes, resulting in changes in a direction of the magnetic field or the magnetic flux density.

In this embodiment, the magnetic field intensity sensing device 94 identifies the pressing state of the key 3 by detecting changes in the magnetic field strength in real time and converting a magnetic signal into an electrical signal. The Hall sensor is used as an example. When the key 3 is not pressed, the magnetic field strength sensed by the Hall sensor remains at an initial value. When the key 3 is pressed, the second magnet 42 moves closer to the Hall sensor, increasing the magnetic field strength and causing a change in a voltage signal output by the Hall sensor, thereby generating a trigger signal of the key 3.

In addition, a threshold for the magnetic field strength can be set to ensure that the signal change is sufficiently distinct when the key 3 is pressed, preventing issues such as false triggering or insufficient sensitivity. For a matrix of the plurality of keys 3, the magnetic field sensing device can also employ row-column scanning technology to reduce the quantity of sensors, improve detection efficiency, and ensure accurate recognition of the input state of each key 3 even when the plurality of keys 3 are simultaneously pressed. The magnetic field detection method in this embodiment not only provides non-contact and highly durable input detection of the key 3 but also reduces mechanical wear, thereby prolonging the device's service life and improving reliability.

The above description is only intended to illustrate the technical solution of the present invention and not to limit the present invention, and other modifications or equivalent substitutions made by those skilled in the art to the technical solution of the present invention should be covered by the scope of the claims of the present invention without departing from the spirit and scope of the technical solution of the present invention.

What is claimed is:

1. A visually indicative keyboard, comprising:
a front case (1), wherein at least one accommodation hole (2) is provided on the front case (1);
at least one key (3) made of light-transmitting materials, disposed in the accommodation hole (2) and capable of performing reciprocating movement relative to the accommodation hole (2);
a display module (5), disposed below the front case (1) for providing a visually indicative image to a user via the key (3); and
a reset module (4), wherein the reset module (4) comprises a first magnet (41) and a second magnet (42), wherein
at least one side adjacent to the accommodation hole (2) is provided with a first groove (21), and the first magnet (41) is disposed in the first groove (21); the key (3) comprises a plurality of side surfaces, at least one side surface of the key (3) is provided with a second groove (31), and the second magnet (42) is disposed in the second groove (31); and
when the key (3) is not pressed, a top surface (11) of the key is higher than a top surface (11) of the front case (1), and an initial state is maintained by the magnetic force between the first magnet (41) and the second magnet (42); or when the user presses the key (3), the magnetic force provides a restoring force for resetting the key (3).

2. The visually indicative keyboard according to claim 1, wherein at least one side surface of the key (3) is provided with a guide strip (33), an inner wall of the accommodation hole (2) is provided with a guide groove (23) that is engaged with the guide strip (33), and when the user presses the key (3), the guide strip (33) slides along the guide groove (23).

3. The visually indicative keyboard according to claim 2, wherein at least one inner wall of the accommodation hole (2) is further provided with a first limiting portion (22), at least one side surface of the key (3) is further provided with a second limiting portion (32), and when the key (3) is not pressed, the second limiting portion (32) abuts against the first limiting portion (22).

4. The visually indicative keyboard according to claim 3, wherein the first limiting portion (22) comprises a first sliding surface (221), a first cross-sectional surface (222), and a second sliding surface (223), with the first cross-sectional surface (222) connected between the first sliding surface (221) and the second sliding surface (223); the second limiting portion (32) comprises a third sliding surface (321), a second cross-sectional surface (322), and a fourth sliding surface (323), with the second cross-sectional surface (322) connected between the third sliding surface (321) and the fourth sliding surface (323); and when the key (3) is not pressed, the second cross-sectional surface (322) abuts against the first cross-sectional surface (222).

5. The visually indicative keyboard according to claim 2, further comprising a supporting member (6) and a bottom case (7), wherein the bottom case (7) is detachably connected to the front case (1), the supporting member (6) is provided with a limiting member (63), and the limiting member (63) is configured to secure a circuit board (8).

6. The visually indicative keyboard according to claim 2, further comprising a detection module (9), wherein the detection module (9) is configured to sense an action of the key (3).

7. The visually indicative keyboard according to claim 6, wherein the detection module (9) comprises a touch panel (91) disposed between the display module (5) and the key (3), and when the key is pressed, the touch panel (91) is capable of detecting an input signal of the key (3) through contact with the key (3).

8. The visually indicative keyboard according to claim 7, wherein the detection module (9) comprises a light-sensitive lamp panel (92) and an optical sensor (93) disposed on the light-sensitive lamp panel (92), and when the key is pressed, the optical sensor (93) can detect the input signal of the key (3) through light intensity, reflection, refraction, or obstruction.

9. The visually indicative keyboard according to claim 8, wherein the detection module (9) comprises a magnetic field intensity sensing device (94), and when the key is pressed, the magnetic field intensity sensing device (94) is capable of detecting the input signal of the key (3) through changes in the magnetic field.

10. The visually indicative keyboard according to claim 9, further comprising a PVC top cover (10), wherein the PVC top cover (10) is disposed between the display module (5) and the front case (1).
